(19) United States
(12) Patent Application Publication
(10) Pub. No.: US 2009/0152074 A1
(43) Pub. Date: Jun. 18, 2009

(54) CONVEYOR DIVERTER

(75) Inventor: Stephen C. Wolf, Grand Rapids, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: DEMATIC CORP., Grand Rapids, MI (US)

(21) Appl. No.: 12/329,934

(22) Filed: Dec. 8, 2008

Related U.S. Application Data
(60) Provisional application No. 61/013,337, filed on Dec. 13, 2007.

(51) Int. Cl. B65G 47/46; B65G 43/08; B65G 47/00

(52) U.S. Cl. 198/617; 198/370.1; 198/358

(57) ABSTRACT

A conveyor diverter and method provides a device for diverting articles from a transport conveyor at increased throughput by urging a subsequent article onto the diverter before a prior article has been directed off of the diverter. The diverter raises a downstream portion of diverter surface while leaving upstream portions of the diverter surface in a lowered position, thereby permitting articles entering the diverter in a first direction to be diverted in a second direction. The diverter includes a transport conveying surface for conveying articles in the first direction and a lift assembly for raising and lowering the upstream portions and downstream portions of the diverter surface. The diverter may be configured to provide turn, cross-transfer, cross-transfer with increased throughput, and transport functions. Thus, a method is provided for achieving increased throughput and/or multiple divert functions.

### CROSS REFERENCE TO RELATED APPLICATION

The present application claims the benefit of U.S. Provisional Application, Ser. No. 61/013,337, filed Dec. 13, 2007, which is hereby incorporated herein by reference in its entirety.

### FIELD OF THE INVENTION

The present invention relates generally to powered conveyors and, more particularly, to diverters for powered conveyors.

### BACKGROUND OF THE INVENTION

Powered conveyors are known to include diverters for directing objects such as packages off of the conveyors. The diverters may be selectively engaged to direct only a subset of the objects conveyed on the conveyor, and may direct the objects onto another conveyor, a buffer, a collection area, or the like.

### SUMMARY OF THE INVENTION

Embodiments of the present invention provide a diverter that is suitable for transporting, cross-transferring, or diverting articles along or from a conveyor. A lift assembly is provided that is capable of lifting a downstream portion of the diverter, or both an upstream portion and the downstream portion of the diverter, in order to effect diverting or cross-transferring of articles positioned thereon. Embodiments further provide for close spacing of articles located on the transport conveyor by raising a downstream portion of the diverter to provide a transport region at the upstream portion of the diverter and a divert region at the downstream portion of the diverter.

According to one aspect of the invention, a diverter is provided to divert articles from a transport conveyor. The diverter includes a transport conveying surface, a base frame, a diverter support frame, a diverter surface, a lift assembly, and a control. The transport conveying surface conveys articles in a longitudinal direction along the diverter. The diverter support frame is movably supported at the base frame. The diverter surface is supported at the diverter support frame in juxtaposition with the transport conveying surface. The diverter surface has a downstream portion with respect to movement of articles on the transport conveying surface, and laterally diverts articles traveling on the transport conveying surface off of a side of the diverter. The lift assembly is positioned at the base frame and raises the downstream portion of the diverter surface to divert an article from the transport conveying surface. The control selectively actuates the lift assembly.

The diverter may be adapted to provide a cross-transfer function, a divert function, and/or a staged-drop divert function, such as by reconfiguring the lift assembly. The lift assembly may include a motor that drives one or more cams via link members or belts. The cams may be dwell cams to provide a staged-drop function during cross-transfer or a turn function, for example. The transporter members may be sheaves having continuous belts reeved thereon and arranged in spaces between the diverter surface, which may be made up of spaced rollers.

Thus, a method is provided for increasing the throughput of articles across a diverter by raising only a downstream portion of the diverter. By reconfiguring a lift mechanism of the diverter, the diverter may provide increased throughput, a cross-transfer function, a staged-drop cross-transfer function, a divert or turn function, and/or a transport function.

These and other objects, advantages, purposes, and features of the present invention will become apparent upon review of the following specification in conjunction with the drawings.

### BRIEF DESCRIPTION OF THE DRAWINGS

FIG. 1 is a front elevation of a diverter in accordance with the present invention;

FIG. 2 is a right side elevation of the diverter of FIG. 1, having portions of a base frame removed;

FIG. 3 is a top plan of the diverter of FIG. 1, having rollers and a roller support frame removed;

FIG. 4 is a front elevation of the diverter of FIG. 1 in a divert mode;

FIG. 5 is a right side elevation of the diverter of FIG. 4, having portions of the base frame removed;

FIG. 6 is a right side elevation of the diverter in a cross-transfer mode;

FIG. 7 is a right side elevation of the diverter of FIG. 6, having the rollers and the roller support frame removed;

FIG. 8 is a right side elevation of the diverter of FIG. 7, having the lift assembly in a lowered position;

FIG. 9 is a right side elevation of the diverter having an alternative embodiment lift assembly in a staged-drop cross-transfer mode;

FIG. 10 is a right side elevation of the diverter of FIG. 9, having the lift assembly in a fully raised position;

FIG. 11 is a right side elevation of the diverter of FIGS. 9 and 10, having the lift assembly in a staged-drop position;

FIGS. 12A-12C are front elevations and corresponding right side elevations of the diverter of FIGS. 9-11, depicting the steps of the staged-drop cross-transfer mode;

FIGS. 13A-13 are front elevations and corresponding right side elevations of the diverter of FIG. 9, depicting the steps of a turn mode;

FIG. 14 is a top plan of a transport conveyor incorporating the diverter in a left-hand divert mode;

FIG. 15 is a top plan of a second transport conveyor incorporating a pair of diverters in right-hand divert modes to effect a 180 degree turn; and

FIG. 16 is a top plan of a third transport conveyor incorporating the diverter in a centering mode.

### DESCRIPTION OF THE PREFERRED EMBODIMENTS

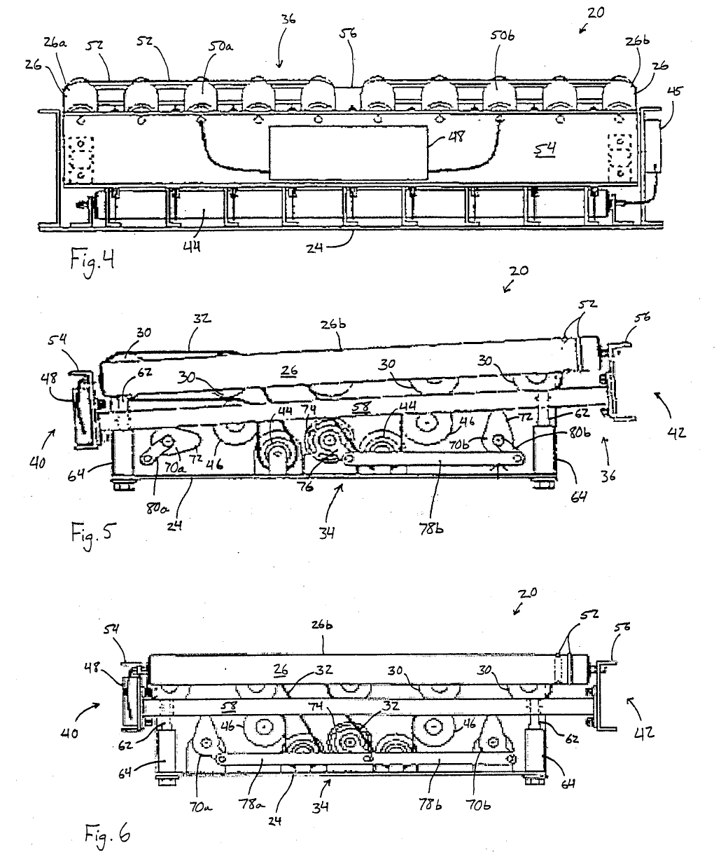

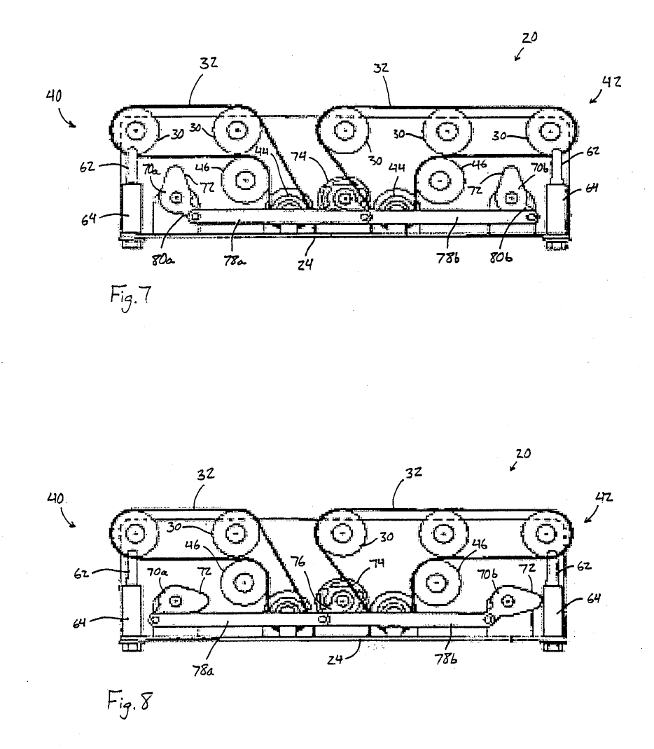

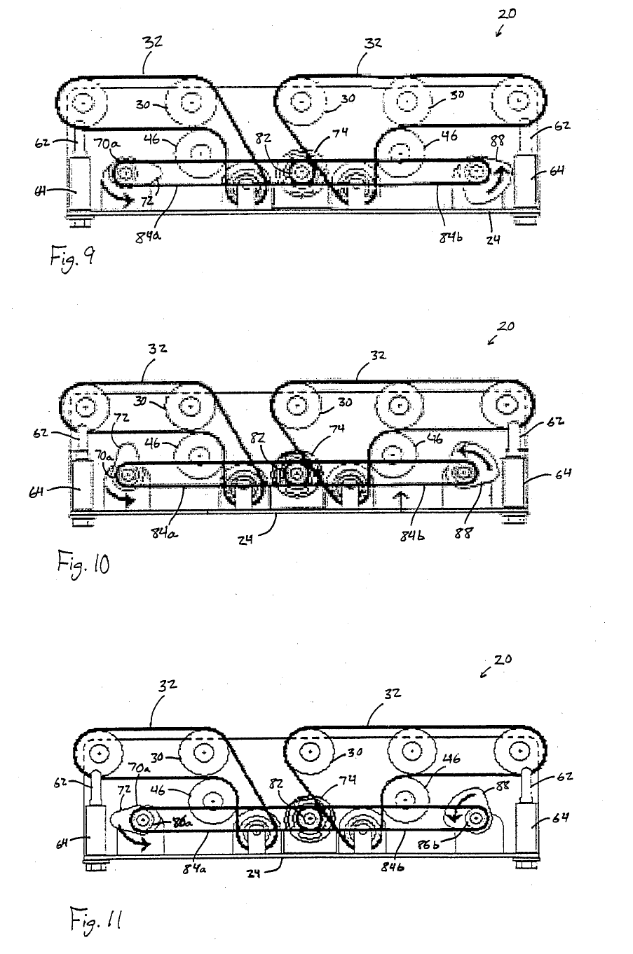

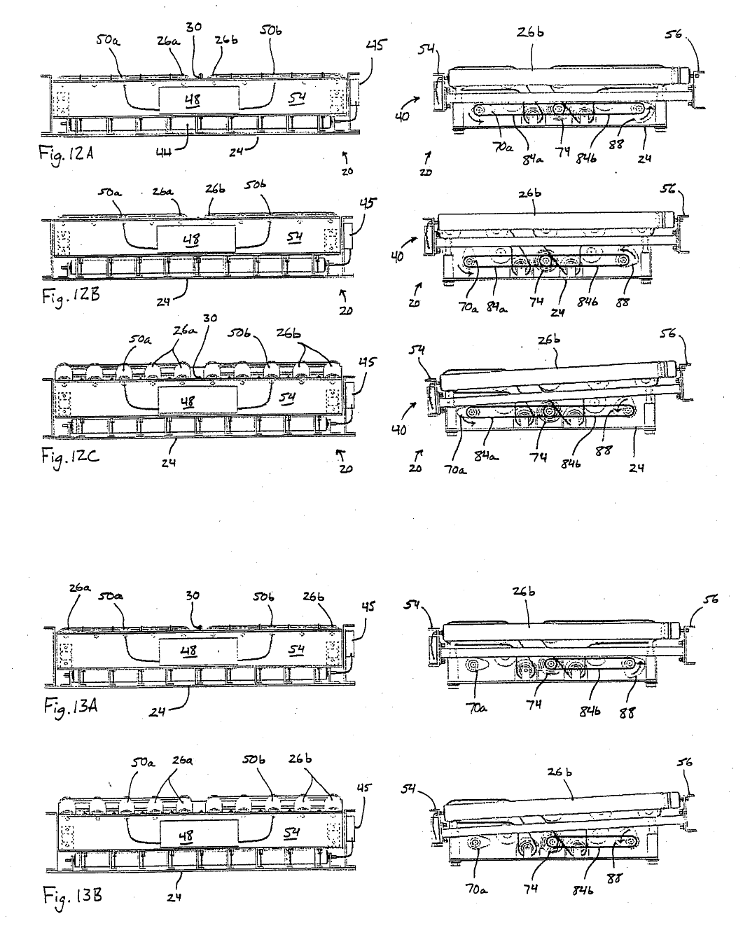

Referring now to the drawings and the illustrative embodiments depicted therein, a diverter 20 for a transport conveyor 22 includes a base frame 24, a diverter surface including a plurality of diverter members such as rollers 26 for diverting or transferring articles 28 from conveyor 22, a plurality of transporter members such as endless drive belts 32 for transporting articles 28 along conveyor 22, and a lift assembly 34 for selectively raising portions of rollers 26 (FIGS. 1-3 and 14). A roller support frame 36 rotatably supports rollers 26 and is itself movably supported at base frame 24. Sheaves 30 support endless drive belts 32. A sheave support frame 38 (FIG. 3) rotatably supports sheaves 30 at base frame 24, as will be described in greater detail below.

Diverter 20 has an upstream end 40 and a downstream end 42 opposite upstream end 40. It will be understood that downstream end 42 refers to the end of diverter 20 from which articles 28 are discharged when they are not diverted by diverter 20 but instead are transported along diverter in the transport direction of conveyor 22. Sheaves 30, supported at sheave support frames 38, are driven by one or more electric motors, such as motorized rollers 44 having endless drive belts 32 routed from sheaves 30 to one of motorized rollers 44 (FIGS. 1-11). Optionally, and as shown, an idler roller or idler sheave 46 maintains tension and alignment of drive belts 32 at corresponding sheaves 30.

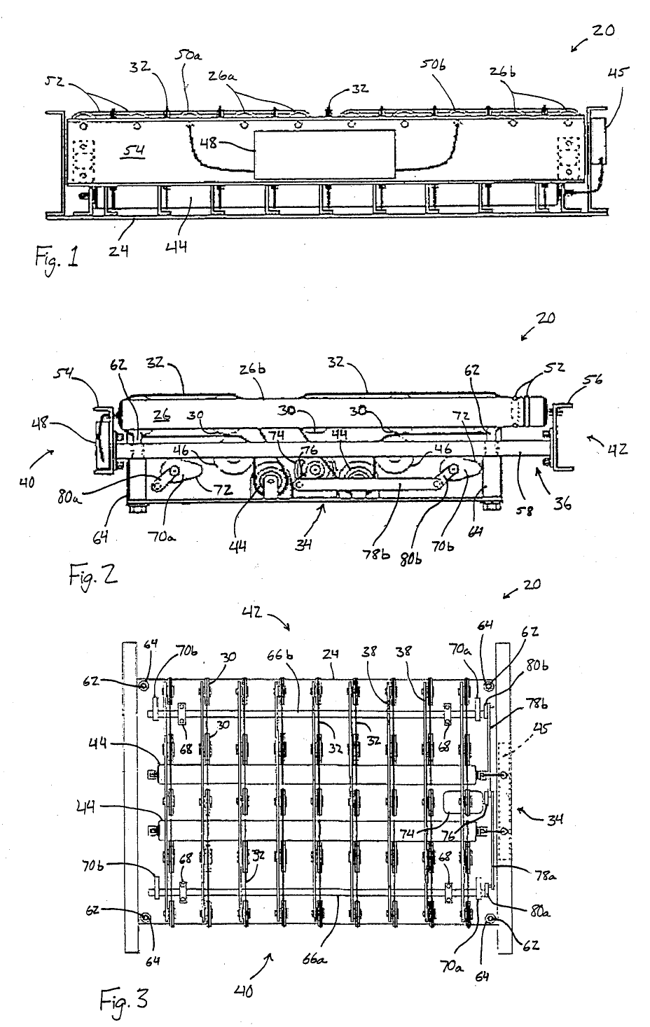

With roller support frame 36 in its fully lowered position (FIG. 2), upper portions of sheaves 30 and endless drive belts 32 extend above rollers 26 and are operable to convey articles 28 from upstream end 40 to downstream end 42. Motorized rollers 44 may be driven substantially constantly to convey articles 28 partially along diverter 20 between upstream end 40 and downstream end 42 until articles 28 are diverted off of a side of diverter 20 when downstream portions of rollers 26 are raised by lift assembly 34. Motorized rollers 44 may be driven to convey articles 28 longitudinally along or across diverter 20 so that articles 28 are received upstream end 40 and discharged at downstream end 42 without raising rollers 26 while articles are supported at drive belts 32 of diverter 20. Optionally, motorized rollers 44 may be controlled via a roller controller 45 to provide constant or intermittent operation of drive belts 32.

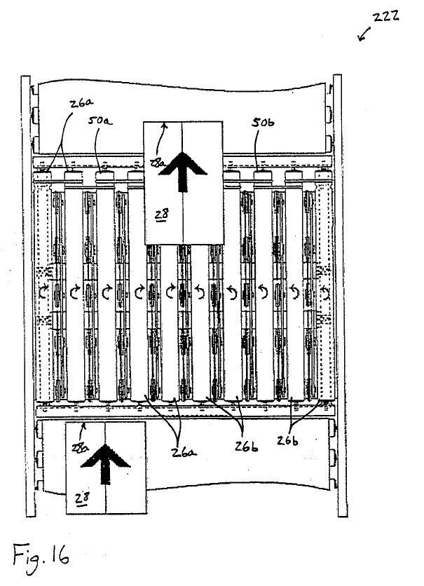

As best seen in FIG. 4, rollers 26 are arranged parallel to one another and may include two separately controlled sets of rollers 26a, 26b controlled by a roller controller 48 mounted at upstream end 40 of diverter 20 at roller support frame 36. Each set of rollers 26a, 26b may include a motorized roller 50a, 50b, each of which is controlled by roller controller 48. Rollers 26a, 26b are connected to motorized rollers 50a, 50b, respectively, in a conventional manner using link belts 52 to interconnect rollers 26a to motorized roller 50a and/or to an adjacent roller 26a, and to interconnect rollers 26b to motorized roller 50b and/or to an adjacent roller 26b. Roller controller 48 is operable to drive rollers 26a in the same direction as rollers 26b (FIGS. 14 and 15), to drive rollers 26a and rollers 26b oppositely and toward the center of diverter 20 (FIG. 16), and to drive rollers 26a and rollers 26b oppositely away from the center of diverter 20.

In the illustrated embodiments, rollers 26 are rotatably supported at and between an upstream-end support 54 and a downstream-end support 56 of roller support frame 36 (FIGS. 2 and 4). Upstream-end support 54 is connected to downstream-end support 56 by a pair of cross members 58. Cross members 58 incorporate apertures 64 receiving locating pins 62 of base frame 24, and rest upon support blocks 64 from which locating pins 62 extend upwardly. Support blocks 64 support cross members 58 of roller support frame 36 at the lowered position (FIG. 2). Locating pins 62 guide roller support frame 36 as the upstream portion and/or downstream portion of roller support frame 36 is raised relative to base frame 24 by lift assembly 34 (FIGS. 5 and 6).

In the illustrated embodiments, lift assembly 34 includes a pair of transverse rods 66a, 66b (FIG. 3). Transverse rod 66a is located proximate upstream end 40 and transverse rod 66b is located proximate downstream end 42. Transverse rods 66a, 66b are pivotably or rotatably supported in journals 68, which are attached to base frame 24. A lifting cam 70a is positioned at an end of each rod 66a, 66b and aligned underneath cross member 58 of roller support frame 36. Similarly, a lifting cam 70b is positioned at an opposite end of each transverse rod 66a, 66b and aligned underneath an opposite cross member (not shown). Lifting cams 70a, 70b are pivotable or rotatable by rotating transverse rod 66a, 66b and include lobes 72 (FIG. 5) that contact cross members 58 to urge roller support frame 36 upwardly and to lower roller support frame 36 to rest at its lowered position.

Lift assembly 34 includes a motor 74 for pivotably or rotatably driving transverse rods 66a, 66b and lifting cams 70a, 70b (FIGS. 2, 3, and 5-8). Motor 74 includes an output arm 76 that is connected to transverse rod 66b by a removable link 78b at a first end of link 78b. Link 78b is connected at a second end to a connecting link 80b mounted to the end of transverse rod 66b. Similarly, and as shown in FIG. 3 and 6-8, output arm 76 of motor 74 may be connected to transverse rod 66a via a removable link 78a and a connecting link 80a. Thus, by selecting which of links 78a, 78b is installed at lift assembly 34, a user may select whether motor 74 is drivable to rotate either or both of transverse rods 66a, 66b. Optionally, and as shown in FIGS. 9-13B, motor 74 may include a pair of drive pulleys or sheaves 82 for driving removable belts 84a, 84b, which are reeved upon input sheaves 86a, 86b located at ends of transverse rods 66a, 66b, respectively. In such an embodiment, an operator may select whether motor 74 is operable to rotate either or both of transverse rods 66a, 66b by selectively removing or replacing removable belts 84a, 84b from lift assembly 34.

Optionally, and as shown in FIGS. 9-13B, the lifting cams at either or both of transverse rods 66a, 66b may be dwell cams 88 for supporting an end of roller support frame 36 in its raised position for a longer period of time than is provided by lobes 72 of lifting cams 70a, 70b. Dwell cams 88 provide a staged-drop function, as will be described in greater detail below, and may be pivoted or rotated by belts 84a, 84b or by links 78a, 78b.

Accordingly, lift assembly 34 is operable to raise roller support frame 36 via the rotation of lifting cams 70 or dwell cams 88. For example, and with reference to FIGS. 4 and 5, motor 74 may be actuated to drive lifting cam 70b until lobe 72 is oriented substantially vertically upward, which urges the downstream portion of roller support frame 36 and rollers 26 upwardly so that the downstream portions of rollers 26 are positioned above drive belts 32. In this configuration, articles 28 entering diverter 20 from upstream end 40 are initially carried toward downstream end 42 of diverter 20 by drive belts 32. When a leading portion 28a of article 28 contacts rollers 26, leading portion 28a is initially diverted in the direction of rotation of rollers 26, such as indicated by curved arrows in FIG. 14. The entirety of package 28 is subsequently diverted in the direction of rotation of rollers 26, as in FIGS. 14 and 15.

When only removable link 78b (or removable belt 84b) is installed at lift assembly 34, only the downstream portion of roller support frame 36 is moved to its raised position when motor 74 is actuated to rotate lifting cams 70a, 70b on transverse rod 66b (FIGS. 2, 5, 13A, and 13B). Thus, diverter 20 may be used to simultaneously change the orientation and travel direction of articles 28 that are first carried by drive belts 32, and then by rollers 26, as in FIGS. 14 and 15.

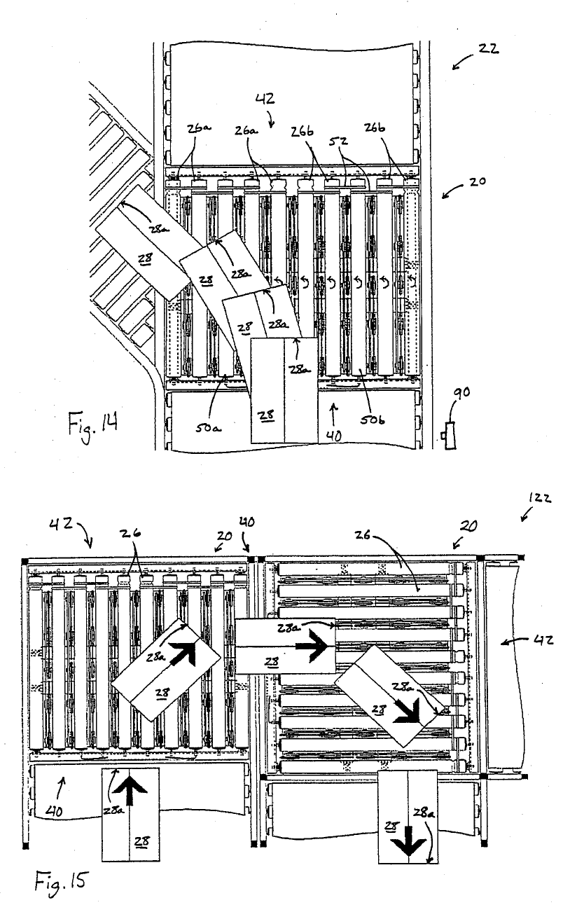

With reference to FIGS. 6-12C, removable links 78a, 78b (or removable belts 84a, 84b) may both be installed at lift assembly 34 to raise the entire roller support frame 36 upon actuation of motor 74 to effect a cross-transfer of articles 28 without reorienting the articles. The through-put rate of articles 28 handled by diverter 20 in the diverter's cross-transfer mode may be increased by using a staged-drop arrangement of lifting cams 70a at transverse rods 66a, and dwell cams 88 at transverse rod 66b (FIGS. 9-12C). Initially, lifting cams 70a and dwell cams 88 are in their lowered position (FIGS. 9 and 12A). Lifting cams 70a and dwell cams 88 are subsequently rotated approximately 90 degrees (FIGS. 10 and 12B) in order to raise roller support frame 36 and position rollers 26 above drive belts 32. By rotating lifting cams 70a and dwell cams 88 approximately 90 degrees further (FIGS. 11 and 12C), lobes 72 of lifting cams 70a move out of contact with cross members 58 to lower the upstream portion of roller support frame 36, while dwell cams 88 continue to support the downstream portion of roller support frame 36 in its raised position, similar to the configuration as in FIGS. 4 and 5.

In the cross-transfer mode having a staged-drop (FIGS. 9-12C), articles 28 may be received at upstream end 40 of diverter 20 upon drive belts 32 while downstream articles 28 are being diverted off of diverter 20 by rollers 26. As lifting cams 70 and dwell cams 88 continue to rotate in response to motor 74, dwell cams 88 lower the downstream portion of roller support frame 36 before the entire roller support frame 36 is once again raised by lifting cams 70 and dwell cams 88 in order to cross-transfer the next package in substantially the same orientation at which the package arrived at upstream end 40 of diverter 20.

Optionally, a package sensor 90 may be provided at transport conveyor 22 upstream of diverter 20 (FIG. 14). Package sensor 90 detects articles 28 on conveyor 22 and sends a signal to roller controller 48 to automate functions such as cross-transfer and cross-transfer with staged-drop. Roller controller 48 receives the signal and calculates the appropriate moment to actuate motor 74 to raise at least a portion of rollers 26 based upon the speed of articles 28 along conveyor 28, the distance of sensor 90 from diverter 20, and the time elapsed since the signal from sensor 90 was received. Thus, in cross-transfer mode, sensor 90 permits controller 48 to signal motor 74 to raise the entirety of roller support frame 36 and rollers 26 when an article is positioned fully upon diverter 20. Similarly, in staged-drop mode, sensor 90 permits controller 48 to signal motor 74 to lower the upstream portion of frame 36 and rollers 26 when an article is approaching upstream end 40 of diverter 20. In divert mode, sensor 90 permits controller 48 to signal motor 74 to raise the downstream portion of frame 36 and rollers 26 when an article that needs to be diverted is entering diverter 20, and to lower the downstream portion of frame 36 and rollers 26 when an article that needs to be transported across diverter 20 without being diverted is entering diverter 20.

Accordingly, diverter 20 is operable to transport articles 28 from upstream end 40 to downstream end 42 via endless drive belts 32, is capable of turning or reorienting articles 28 while diverting the articles to one side or the other, and is further capable of cross-transferring articles 28 off of a side of diverter 20 without reorienting the articles. By driving rollers 26a oppositely from rollers 26b, bi-direction divert, bi-direction cross-transfer, and centering functions are enabled, as will be described in greater detail below. Diverter 20 is also operable to provide a staged-drop cross-transfer that increases the throughput rate of articles 28 along transport conveyor 22 by permitting diverter 20 to receive a second article at upstream end 40 while laterally discharging a first article. Thus, the mode of diverter 20 (e.g. transport mode, divert mode, cross-transfer mode, staged-drop cross-transfer mode, bi-direction divert mode, bi-direction cross-transfer mode, centering mode, transport mode) may be selected by adding or replacing one or more of removable links 78a, 78b, removable belts 84a, 84b, dwell cams 88, and lifting cams 70, in addition to controlling motor 74 and drive belts 32 via roller controller 48. However, it will be appreciated that the various modes of diverter 20 may be accomplished via a plurality of independently controllable actuators positioned beneath the upstream portion and downstream portion of roller support frame 36 and controlled via a function-controller, for example. In such an embodiment, a plurality of actuators, such as electrical, pneumatic, or hydraulic actuators or the like, may be positioned and controlled to raise one or both ends of rollers 26 and provide any of the desired functions of diverter 20 without need for installing or removing cams, removable links, removable belts, or the like.

Diverter 20 of conveyor 22 raises discharge end 42 of rollers 26 to turn and divert articles to the left (FIG. 14). By controlling the speed of rollers 26, articles may be turned and diverted laterally up to about 90° from the longitudinal transport direction (FIG. 15). Optionally, a conveyor 122 may be equipped with two or more diverters 20 to turn or cross-transfer articles 28 by more than 90°.

Optionally, a conveyor 222 may be equipped with diverter 20 set to provide a centering function (FIG. 16) in which roller controller 48 directs rollers 26a and rollers 26b to rotate toward the center of diverter 20, thereby directing any off-center articles toward the center of diverter, such as by raising the entire roller support frame 36 momentarily with an article positioned thereon, before lowering lower support frame 36 so that articles 28 are carried off downstream end 42 of diverter 20 by endless drive belts 32. Optionally, rollers 26a and rollers 26b may be driven to rotate away from the center of diverter 20 so that diverter 20 may be used to simultaneously turn, divert, or cross-transfer articles in opposite lateral directions (i.e. bi-directional turn or bi-directional cross-transfer) according to their lateral position on diverter 20.

Changes and modifications in the specifically described embodiments may be carried out without departing from the principles of the present invention, which is intended to be limited only by the scope of the appended claims, as interpreted according to the principles of patent law including the doctrine of equivalents.

The embodiments of the invention in which an exclusive property or privilege is: claimed are defined as follows:

1. A diverter for a transport conveyor, said diverter comprising:
a transport conveying surface adapted to convey articles in a longitudinal direction;
a base frame;
a diverter support frame movably supported at said base frame;
a diverter surface at said diverter support frame in juxtaposition with said transport conveying surface, said diverter surface adapted to laterally divert articles traveling on said transport conveying surface, said diverter surface having a downstream portion with respect to movement of articles on said transport conveying surface;
a lift assembly at said base frame, said lift assembly adapted to raise said downstream portion of said diverter surface to divert an article from said transport conveying surface; and
a control, said control adapted to selectively actuate said lift assembly.

2. The diverter according to claim 1, wherein said diverter surface can be driven in a lateral direction and an opposite lateral direction.

3. The diverter according to claim 1, said diverter further comprising:
a plurality of spaced transporter members, said transporter members adapted to convey articles in the longitudinal direction;
a transport frame supported at said base frame, said transport frame adapted to support said transporter members; and
a plurality of spaced diverter members supported at said diverter support frame and arranged between said transporter members.

4. The diverter according to claim 3, wherein said transporter members comprise a plurality of sheaves having continuous belts reeved thereon.

5. The diverter according to claim 4, wherein said diverter members comprise rollers.

6. The diverter according to claim 5, wherein said diverter members comprise left diverter members and right diverter members, said left and right diverter members being independently controllable by a diverter surface controller.

7. The diverter according to claim 6, wherein said left diverter members are drivable rightwardly and said right diverter members are drivable leftwardly to center an article at said diverter surface.

8. The diverter according to claim 1, wherein said lift assembly comprises: a motor at said base frame;
a cam spaced from said motor at said base frame;
a link member having a first end mounted at said motor and a second end mounted at said cam; and
wherein said cam is pivotable by said link member in response to said motor to raise said downstream portions of said diverter surface.

9. The diverter according to claim 8, wherein said lift assembly further comprises:
a second link member at said motor;
a second cam at said second link member; and
wherein said second cam is pivotable by said second link member in response to said motor to raise an upstream portion of said diverter surface.

10. The diverter according to claim 9, wherein said link members comprise endless belts.

11. The diverter according to claim 1, further comprising an article sensor adapted to sense an article at said diverter, wherein said control is adapted to actuate said lift assembly in response to said article sensor.

12. The diverter according to claim 1, wherein said lift assembly is adapted to raise an upstream portion of said diverter surface substantially simultaneously with said downstream portion of said diverter surface to laterally cross-transfer off of said diverter surface an article initially moving in said longitudinal direction along said transport conveying surface.

13. The diverter according to claim 12, wherein said lift assembly is adapted to lower said upstream portions of said diverter surface after said upstream portions and said downstream portions are raised, wherein said diverter receives a subsequent article at said upstream portions.

14. The diverter according to claim 1, wherein said diverter surface is adapted to laterally divert articles traveling on said transport conveying surface in a direction perpendicular to the longitudinal direction.

15. A diverter for a transport conveyor, said diverter comprising:
a base frame;
a roller support frame movably supported at said base frame;
a sheave support frame supported at said base frame;
a plurality of spaced rollers rotatably supported at said roller support frame, said spaced rollers adapted to convey articles in a lateral direction;
a plurality of sheaves rotatably supported at said sheave support frame and arranged between said spaced rollers, said sheaves adapted to convey articles in a longitudinal direction; and
a lift assembly at said base frame, said lift assembly adapted to raise a downstream portion of said roller support frame, with respect to movement of articles on said sheaves, when said lift assembly is actuated;
a control, said control adapted to selectively actuate said lift assembly; and
wherein downstream portions of said spaced rollers are positionable above said sheaves in response to actuation of said lift assembly by said control.

16. The diverter according to claim 15, further comprising a plurality of endless conveying belts reeved around said plurality of sheaves for conveying articles in a second direction, wherein portions of said spaced rollers are positionable above said endless conveying belts in response to actuation of said lift assembly.

17. The diverter according to claim 15, wherein said lift assembly is adapted to raise an upstream portion of said roller support frame and upstream portions of said spaced rollers when said lift assembly is actuated.

18. The diverter according to claim 15, wherein said lift assembly comprises:
a motor at said base frame;
a cam at said base frame and spaced from said motor;
a link member having a first end mounted at said motor and a second end mounted at said cam; and
wherein said cam is pivotable by said link member in response to said motor to raise said downstream portion of said roller support frame.

19. The diverter according to claim 18, wherein said lift assembly further comprises:
a second link member at said motor;
a second cam at said link member; and
wherein said second cam is pivotable by said second link member in response to said motor to raise said upstream portion of said roller support frame and said upstream portions of said spaced rollers.

20. The diverter according to claim 19, wherein said cam comprises a dwell cam adapted to hold said downstream portion of said roller support frame in a raised position for a period of time after said second cam lowers said upstream portion of said roller support frame.

21. The diverter according to claim 15, wherein said lift assembly comprises:
a motor, said motor having an output sheave;
a cam, said cam having a cam input sheave;
an endless drive member, said endless drive member reeved around said output sheave and said cam input sheave; and
wherein said motor is adapted to rotatably drive said cam via said endless drive member to raise at least a downstream portion of said roller support frame.

22. The diverter according to claim 21, wherein said lift assembly further comprises:
a second cam, said second cam having a second cam input sheave; and
a second endless drive member, said second endless drive member reeved around said output sheave of said motor and said second cam input sheave;
wherein said motor is adapted to rotatably drive said second cam via said second endless drive member to raise at least an upstream portion of said roller support frame.

23. The diverter according to claim 22, wherein said cam comprises a dwell cam adapted to hold said downstream portion of said roller support frame in a raised position for a period of time after said second cam lowers said upstream portion of said roller support frame.

24. The diverter according to claim 21, wherein said endless drive members comprise belts.

25. The diverter according to claim 15, wherein said spaced rollers are adapted to convey articles in a direction perpendicular to the longitudinal direction.

26. A method of diverting articles on a transport conveyor, said method comprising:
directing an article onto a diverter surface at an upstream portion of the diverter;
transporting the article at least partially longitudinally along a transport conveying surface of the diverter with transporter members positioned above the diverter surface;
driving the diverter surface in a lateral direction;
raising downstream portions of the diverter surface above the transport conveying surface with a lift assembly while leaving upstream portions of the diverter surface positioned below the transport conveying surface; and
urging the article off of a side of the diverter with the diverter surface.

27. The method according to claim 26, further comprising:
lowering the downstream portions of the diverter surface below the transport conveying surface; and
urging a subsequent article off of a downstream end of the diverter with the transport conveying surface.

28. The method according to claim 26, further comprising:
driving the diverter surface in an opposite lateral direction; and
urging a subsequent article off of an opposite side of the diverter with the diverter surface.

29. A method of diverting articles on a transport conveyor, said method comprising:
directing a first article onto a diverter at an upstream portion of the diverter;
transporting the first article at least partially longitudinally along the diverter with a transport conveying surface positioned above the diverter surface;
driving the diverter surface in a lateral direction;
raising upstream portions and downstream portions of the diverter surface above the transport conveying surface with a lift assembly;
urging the first article toward a side of the diverter with the diverter surface;
lowering the upstream portions of the diverter surface with the lift assembly while the first article is at least partially supported by the diverter surface; and
directing a second article longitudinally onto the diverter at the upstream portion.

30. The method according to claim 29, further comprising:
transporting the second article at least partially longitudinally along the diverter with the transport conveying surface while directing the first article laterally off of the side of the diverter with the diverter surface;
raising the upstream portions of the diverter surface above the transport conveying surface; and
urging the second article toward a side of the diverter with the diverter surface.

31. The method according to claim 29, further comprising:
detecting a present location of the first article with a sensor;
predicting a time at which the first article will reach the upstream portions of the diverter surface; and
lowering the upstream portions of the diverter surface before the time at which the first article is predicted to reach the upstream portions of the diverter surface.

32. The method according to claim 31, further comprising:
lowering the downstream portions of the diverter surface;
raising the upstream portions and downstream portions of the diverter surface simultaneously to laterally cross-transfer the first article off of a side of the diverter;
detecting a present location of the second article with the sensor;
predicting a time at which the second article will reach the upstream portions of the diverter surface;
lowering the upstream portions of the diverter surface before the time at which the second article is predicted to reach the upstream portions of the diverter surface; and
directing the second article onto the diverter at the upstream portion of the transport conveying surface while the first article is at least partially supported by the diverter surface.
